(19) United States
(12) Patent Application Publication
(10) Pub. No.: US 2025/0374315 A1
(43) Pub. Date: Dec. 4, 2025

(54) INTER-USER-EQUIPMENT INTERFERENCE CANCELLATION FOR PHYSICAL DOWNLINK CONTROL CHANNEL MULTI-USER MULTIPLE-INPUT MULTIPLE-OUTPUT

(71) Applicant: QUALCOMM Incorporated, San Diego, CA (US)

(72) Inventors: Ming YANG, San Diego, CA (US); Kausik RAY CHAUDHURI, San Diego, CA (US); Juan MONTOJO, San Diego, CA (US)

(21) Appl. No.: 18/680,150

(22) Filed: May 31, 2024

(51) Int. Cl. H04W 72/541; H04L 1/00; H04W 72/121; H04W 72/23

(52) U.S. Cl. CPC H04W 72/541; H04L 1/0013; H04W 72/121; H04W 72/23

(57) ABSTRACT

Various aspects of the present disclosure generally relate to wireless communication. Some aspects more specifically relate to inter-user-equipment (inter-UE) interference cancellation (IC) for physical downlink control channel (PDCCH) multi-user multiple-input multiple-output (MU-MIMO). In some aspects, a user equipment (UE) may be configured with an indication of cell radio network temporary identifiers (C-RNTIs) and/or scrambling code identities of respective candidate UEs that use the same or overlapping control-channel elements (CCEs) as the UE. In some aspects, the UE may perform the inter-UE IC by decoding a PDCCH communication targeted for one or more of the candidate UEs and subtracting the decoded PDCCH communication from at least a part of a PDCCH MU-MIMO communication such that the remaining signal includes data targeted for the UE.

### FIELD OF THE DISCLOSURE

Aspects of the present disclosure generally relate to wireless communication and specifically relate to techniques, apparatuses, and methods associated with inter-user-equipment interference cancellation for physical downlink control channel multi-user multiple-input multiple-output.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

“PDCCH blocking” refers to situations in which a network node has insufficient physical downlink control channel (PDCCH) resources to allocate a grant, even if there are sufficient physical downlink shared channel (PDSCH) resources for data associated with the grant. In examples where the same control-channel elements (CCEs) are used for multiple user equipments (UEs), occurrences of missing PDCCHs increase, leading to significant PDCCH blocking issues and suboptimal CCE allocation.

### SUMMARY

Some aspects described herein relate to an apparatus for wireless communication at a user equipment (UE). The apparatus may include one or more memories storing processor-executable code and one or more processors coupled with the one or more memories. At least one processor of the one or more processors may be configured to cause the UE to transmit an indication that the UE is capable of supporting inter-UE interference cancellation (inter-UE IC) associated with physical downlink control channel (PDCCH) multi-user multiple-input multiple-output (MU-MIMO). At least one processor of the one or more processors may be configured to receive, in accordance with the indication that the UE is capable of supporting the inter-UE IC, a PDCCH MU-MIMO inter-UE IC configuration including an indication of one or more scrambling codes corresponding to one or more candidate UEs of PDCCH MU-MIMO. At least one processor of the one or more processors may be configured to receive an indication to perform the inter-UE IC, using the one or more scrambling codes, on one or more PDCCH MU-MIMO communications carried in one or more first control-channel elements (CCEs) that at least partially overlap with one or more second CCEs associated with the one or more candidate UEs.

Some aspects described herein relate to an apparatus for wireless communication at a network node. The apparatus may include one or more memories storing processor-executable code and one or more processors coupled with the one or more memories. At least one processor of the one or more processors may be configured to receive an indication that a UE is capable of supporting inter-UE IC associated with PDCCH MU-MIMO. At least one processor of the one or more processors may be configured to transmit, in accordance with the indication that the UE is capable of supporting the inter-UE IC, a PDCCH MU-MIMO inter-UE IC configuration including an indication of one or more scrambling codes corresponding to one or more candidate UEs of PDCCH MU-MIMO. At least one processor of the one or more processors may be configured to transmit an indication to perform the inter-UE IC, using the one or more scrambling codes, on one or more PDCCH MU-MIMO communications carried in one or more first CCEs that at least partially overlap with one or more second CCEs associated with the one or more candidate UEs.

Some aspects described herein relate to a method of wireless communication performed at a UE. The method may include transmitting an indication that the UE is capable of supporting inter-UE IC associated with PDCCH MU-MIMO. The method may include receiving, in accordance with the indication that the UE is capable of supporting the inter-UE IC, a PDCCH MU-MIMO inter-UE IC configuration including an indication of one or more scrambling codes corresponding to one or more candidate UEs of PDCCH MU-MIMO. The method may include receiving an indication to perform the inter-UE IC, using the one or more scrambling codes, on one or more PDCCH MU-MIMO communications carried in one or more first CCEs that at least partially overlap with one or more second CCEs associated with the one or more candidate UEs.

Some aspects described herein relate to a method of wireless communication performed at a network node. The method may include receiving an indication that a UE is capable of supporting inter-UE IC associated with PDCCH MU-MIMO. The method may include transmitting, in accordance with the indication that the UE is capable of supporting the inter-UE IC, a PDCCH MU-MIMO inter-UE IC configuration including an indication of one or more scrambling codes corresponding to one or more candidate UEs of PDCCH MU-MIMO. The method may include transmitting an indication to perform the inter-UE IC, using the one or more scrambling codes, on one or more PDCCH MU-MIMO communications carried in one or more first CCEs that at least partially overlap with one or more second CCEs associated with the one or more candidate UEs.

Some aspects described herein relate to a non-transitory computer-readable medium that stores a set of instructions for wireless communication. The set of instructions includes one or more instructions that, when executed at a UE, may cause the UE to transmit an indication that the UE is capable of supporting inter-UE IC associated with PDCCH MU-MIMO. The set of instructions includes one or more instructions that, when executed at the UE, may cause the UE to receive, in accordance with the indication that the UE is capable of supporting the inter-UE IC, a PDCCH MU-MIMO inter-UE IC configuration including an indication of one or more scrambling codes corresponding to one or more candidate UEs of PDCCH MU-MIMO. The set of instructions includes one or more instructions that, when executed at the UE, may cause the UE to receive an indication to perform the inter-UE IC, using the one or more scrambling codes, on one or more PDCCH MU-MIMO communications carried in one or more first CCEs that at least partially overlap with one or more second CCEs associated with the one or more candidate UEs.

Some aspects described herein relate to a non-transitory computer-readable medium that stores a set of instructions for wireless communication. The set of instructions includes one or more instructions that, when executed at a network node, may cause the network node to receive an indication that a UE is capable of supporting inter-UE IC associated with PDCCH MU-MIMO. The set of instructions includes one or more instructions that, when executed at the network node, may cause the network node to transmit, in accordance with the indication that the UE is capable of supporting the inter-UE IC, a PDCCH MU-MIMO inter-UE IC configuration including an indication of one or more scrambling codes corresponding to one or more candidate UEs of PDCCH MU-MIMO. The set of instructions includes one or more instructions that, when executed at the network node, may cause the network node to transmit an indication to perform the inter-UE IC, using the one or more scrambling codes, on one or more PDCCH MU-MIMO communications carried in one or more first CCEs that at least partially overlap with one or more second CCEs associated with the one or more candidate UEs.

Some aspects described herein relate to an apparatus for wireless communication. The apparatus may include means for transmitting an indication that the apparatus is capable of supporting inter-UE IC associated with PDCCH MU-MIMO. The apparatus may include means for receiving, in accordance with the indication that the apparatus is capable of supporting the inter-UE IC, a PDCCH MU-MIMO inter-UE IC configuration including an indication of one or more scrambling codes corresponding to one or more candidate UEs of PDCCH MU-MIMO. The apparatus may include means for receiving an indication to perform the inter-UE IC, using the one or more scrambling codes, on one or more PDCCH MU-MIMO communications carried in one or more first CCEs that at least partially overlap with one or more second CCEs associated with the one or more candidate UEs.

Some aspects described herein relate to an apparatus for wireless communication. The apparatus may include means for receiving an indication that a UE is capable of supporting inter-UE IC associated with PDCCH MU-MIMO. The apparatus may include means for transmitting, in accordance with the indication that the UE is capable of supporting the inter-UE IC, a PDCCH MU-MIMO inter-UE IC configuration including an indication of one or more scrambling codes corresponding to one or more candidate UEs of PDCCH MU-MIMO. The apparatus may include means for transmitting an indication to perform the inter-UE IC, using the one or more scrambling codes, on one or more PDCCH MU-MIMO communications carried in one or more first CCEs that at least partially overlap with one or more second CCEs associated with the one or more candidate UEs.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network.

FIG. 2 is a diagram illustrating an example network node in communication with an example user equipment (UE) in a wireless network.

FIG. 3 is a diagram illustrating an example associated with physical downlink control channel (PDCCH) processing.

FIG. 4 is a diagram illustrating an example associated with control resource sets.

FIG. 5 is a diagram illustrating examples associated with mappings of control-channel elements to resource element groups.

FIG. 6 is a diagram illustrating an examples associated with PDCCH rate-matching.

FIG. 7 is a diagram illustrating an example 700 associated with search spaces for respective UEs.

FIG. 8 is a diagram illustrating an example associated with inter-UE interference cancellation (inter-UE IC) for PDCCH multi-user multiple-input multiple-output (MU-MIMO).

FIG. 9 is a flowchart illustrating an example process performed, for example, at a UE or an apparatus of a UE that supports inter-UE IC for PDCCH MU-MIMO.

FIG. 10 is a flowchart illustrating an example process performed, for example, at a network node or an apparatus of a network node that supports inter-UE IC associated with PDCCH MU-MIMO.

FIG. 11 is a diagram of an example apparatus for wireless communication, such as a UE, that supports inter-UE IC associated with PDCCH MU-MIMO.

FIG. 12 is a diagram of an example apparatus for wireless communication, such as a network node, that supports inter-UE IC associated with PDCCH MU-MIMO.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

A network node may perform multiple-input multiple-output (MIMO) communication with at least a first user equipment (UE) and a second UE. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO).

Physical downlink control channel (PDCCH) communications may be transmitted in time-frequency resources of a control resource set (CORESET). For example, a UE may attempt to detect the PDCCH communications by performing blind decoding in one or more control-channel elements (CCEs) of the CORESET. In some MU-MIMO examples, different UEs may be assigned the same or overlapping CCEs, which may increase occurrences of missing PDCCHs and thereby cause significant PDCCH blocking issues. “PDCCH blocking” refers to situations in which a network node has insufficient PDCCH resources to allocate a grant, even if there are sufficient physical downlink shared channel (PDSCH) resources for data associated with the grant.

Various aspects relate generally to inter-UE interference cancellation (inter-UE IC) for PDCCH MU-MIMO. Some aspects more specifically relate to configuring a UE with an indication of scrambling codes of respective candidate UEs for PDCCH MU-MIMO. In some aspects, the indication of the scrambling codes may include an indication of cell radio network temporary identifiers (C-RNTIs) and/or scrambling code identities. The UE may perform the inter-UE IC by decoding a PDCCH communication targeted for one or more of the candidate UEs and subtracting the decoded PDCCH communication from at least a part of a PDCCH MU-MIMO communication such that the remaining signal includes data targeted for the UE.

In some aspects, the indication of the scrambling codes may include an indication of resource element group (REG) bundle sizes configured at the respective candidate UEs, an indication of whether CCE-to-REG mappings configured the respective candidate UEs is interleaved or non-interleaved, and/or an indication of whether the candidate UEs are configured for PDCCH rate-matching with a PDSCH.

In some aspects, the indication of the scrambling codes may be carried by a medium access control (MAC) control element (MAC-CE). In some aspects, the indication of the scrambling codes may be carried by downlink control information (DCI).

Particular aspects of the subject matter described in this disclosure can be implemented to realize one or more of the following potential advantages. In some examples, by configuring the UE with the indication of the scrambling codes of the respective candidate UEs for PDCCH MU-MIMO, the described techniques can be used to enhance PDCCH MU-MIMO by alleviating PDCCH blocking and improving CCE usage. For example, inter-UE IC for PDCCH MU-MIMO may help to decrease the quantity of missing PDCCHs in examples where at least part of a CCE is used for multiple UEs.

In some examples, by configuring the UE with the indication of the scrambling codes including the indication of the REG bundle sizes and/or whether the CCE-to-REG mappings are interleaved or non-interleaved, the described techniques can be used to further improve the inter-UE IC. In some examples, by configuring the UE with the indication of whether the candidate UEs are configured for PDCCH rate-matching with a PDSCH, the described techniques can be used to enable the UE to perform the inter-UE IC on both PDCCH and PDSCH.

In some examples, by carrying the indication of the scrambling codes in the MAC-CE, the described techniques can be used to enable implementation of PDCCH MU-MIMO inter-UE IC. In some examples, by carrying the indication of the scrambling codes in the DCI, the described techniques can be used to perform the inter-UE IC in the same slot in which the DCI is transmitted.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

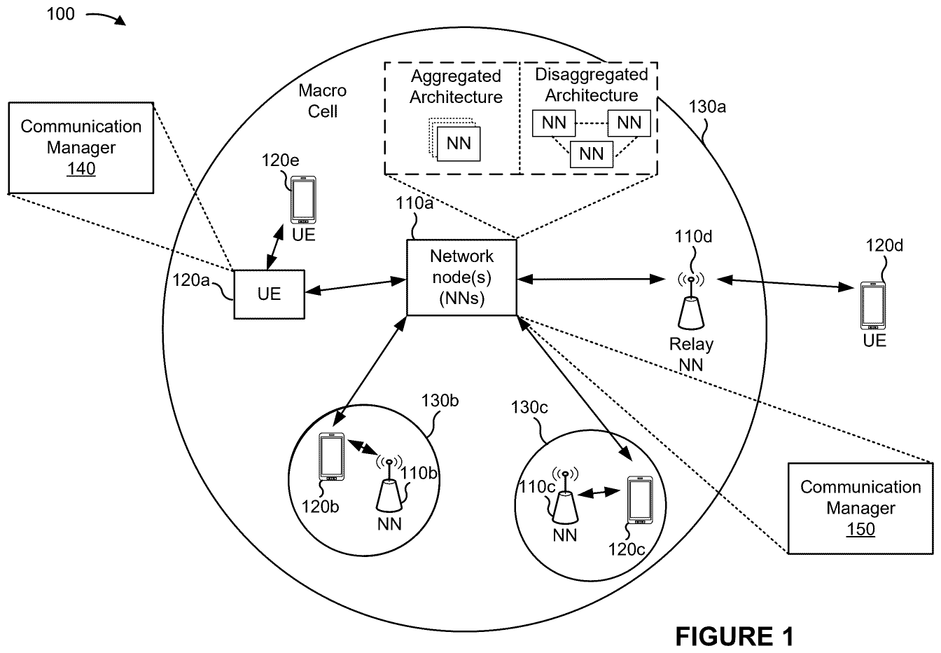

FIG. 1 is a diagram illustrating an example of a wireless communication network 100. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHz), FR2 (24.25 GHz through 52.6 GHz), FR3 (7.125 GHz through 24.25 GHZ), FR4a or FR4-1 (52.6 GHz through 71 GHz), FR4 (52.6 GHz through 114.25 GHZ), and FR5 (114.25 GHz through 300 GHz). Although a portion of FR1 is greater than 6 GHZ, FR1 is often referred to (interchangeably) as a “Sub-6 GHZ” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHZ, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/Long Term Evolution (LTE) and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a MAC layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node.

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, Institute of Electrical and Electronics Engineers (IEEE) compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

In some examples, two or more UEs 120 (for example, shown as UE 120a and UE 120e) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an UL communication to a network node 110, which then transmits the data to the UE 120e in a DL communication.

In some aspects, the UE 120 may include a communication manager 140. As described in more detail elsewhere herein, the communication manager 140 may transmit an indication that the UE 120 is capable of supporting inter-UE IC associated with PDCCH MU-MIMO; receive, in accordance with the indication that the UE 120 is capable of supporting the inter-UE IC, a PDCCH MU-MIMO inter-UE IC configuration including an indication of one or more scrambling codes corresponding to one or more candidate UEs of PDCCH MU-MIMO; and receive an indication to perform the inter-UE IC, using the one or more scrambling codes, on one or more PDCCH MU-MIMO communications carried in one or more first CCEs that at least partially overlap with one or more second CCEs associated with the one or more candidate UEs. Additionally or alternatively, the communication manager 140 may perform one or more other operations described herein.

In some aspects, the network node 110 may include a communication manager 150. As described in more detail elsewhere herein, the communication manager 150 may receive an indication that the UE 120 is capable of supporting inter-UE IC associated with PDCCH MU-MIMO; transmit, in accordance with the indication that the UE 120 is capable of supporting the inter-UE IC, a PDCCH MU-MIMO inter-UE IC configuration including an indication of one or more scrambling codes corresponding to one or more candidate UEs of PDCCH MU-MIMO; and transmit an indication to perform the inter-UE IC, using the one or more scrambling codes, on one or more PDCCH MU-MIMO communications carried in one or more first CCEs that at least partially overlap with one or more second CCEs associated with the one or more candidate UEs. Additionally or alternatively, the communication manager 150 may perform one or more other operations described herein.

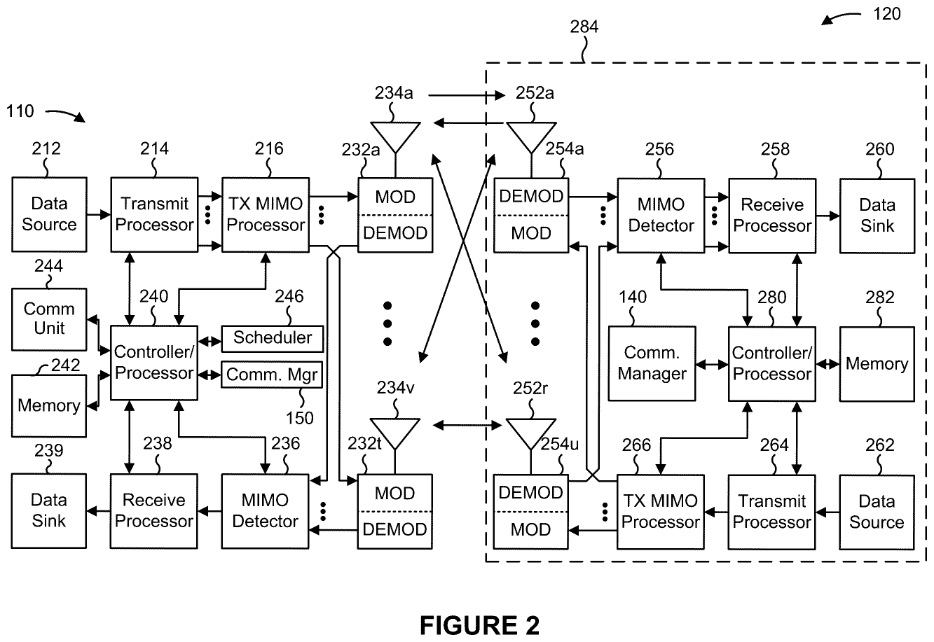

FIG. 2 is a diagram illustrating an example network node 110 in communication with an example UE 120 in a wireless network.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor” or “a/the controller/processor,” among other examples (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more modulation and coding schemes (MCSs) for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include an uplink control information (UCI) communication, a MAC-CE communication, an RRC communication, or another type of uplink communication. Uplink signals may be transmitted on a physical uplink scheduled channel (PUSCH), a physical uplink control channel (PUCCH), and/or another type of uplink channel. An uplink signal may carry one or more transport blocks (TBs) of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range. The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal.

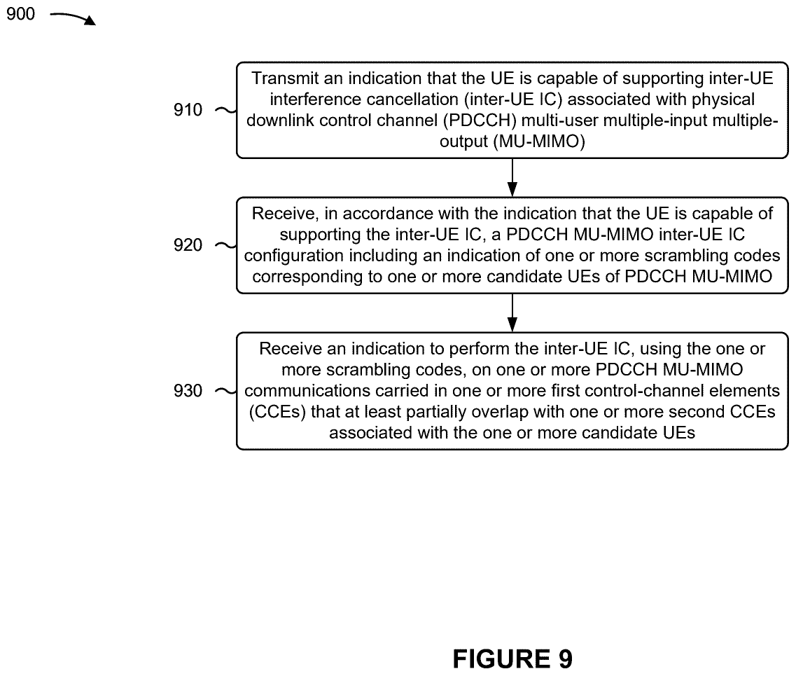

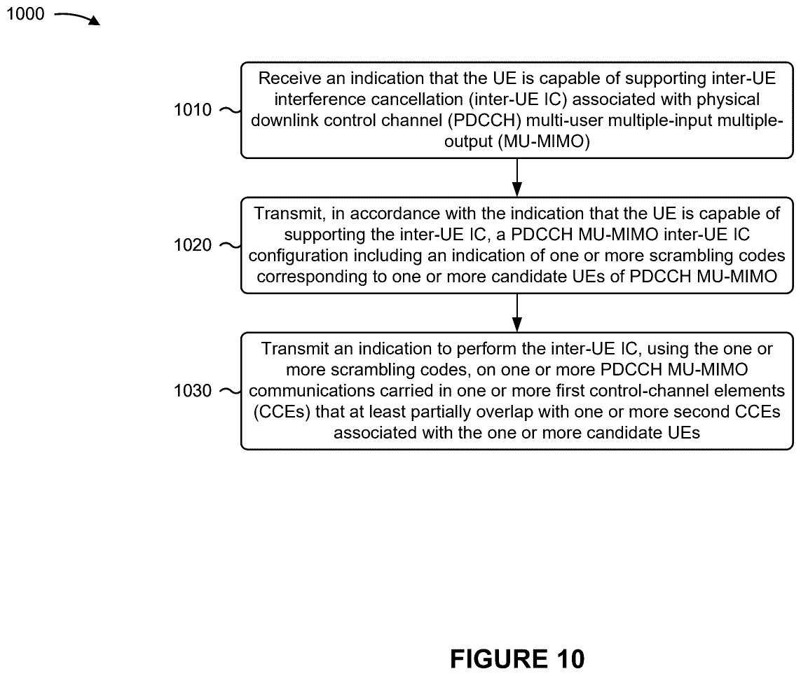

The network node 110, the controller/processor 240 of the network node 110, the UE 120, the controller/processor 280 of the UE 120, a CU, a DU, an RU, or any other component(s) of FIG. 1 or 2 may implement one or more techniques or perform one or more operations associated with inter-UE IC for PDCCH MU-MIMO, as described in more detail elsewhere herein. For example, the controller/processor 240 of the network node 110, the controller/processor 280 of the UE 120, any other component(s) of FIG. 2, the CU, the DU, or the RU may perform or direct operations of, for example, process 900 of FIG. 9, process 1000 of FIG. 10, or other processes as described herein (alone or in conjunction with one or more other processors). The memory 242 may store data and program codes for the network node 110, the network node 110, the CU, the DU, or the RU. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU, the DU, or the RU, may cause the one or more processors to perform process 900 of FIG. 9, process 1000 of FIG. 10, or other processes as described herein. In some examples, executing instructions may include running the instructions, converting the instructions, compiling the instructions, and/or interpreting the instructions, among other examples.

In some aspects, the UE 120 includes means for transmitting an indication that the UE 120 is capable of supporting inter-UE IC associated with PDCCH MU-MIMO; means for receiving, in accordance with the indication that the UE 120 is capable of supporting the inter-UE IC, a PDCCH MU-MIMO inter-UE IC configuration including an indication of one or more scrambling codes corresponding to one or more candidate UEs of PDCCH MU-MIMO; and/or means for receiving an indication to perform the inter-UE IC, using the one or more scrambling codes, on one or more PDCCH MU-MIMO communications carried in one or more first CCEs that at least partially overlap with one or more second CCEs associated with the one or more candidate UEs. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for receiving an indication that the UE 120 is capable of supporting inter-UE IC associated with PDCCH MU-MIMO; means for transmitting, in accordance with the indication that the UE 120 is capable of supporting the inter-UE IC, a PDCCH MU-MIMO inter-UE IC configuration including an indication of one or more scrambling codes corresponding to one or more candidate UEs of PDCCH MU-MIMO; and/or means for transmitting an indication to perform the inter-UE IC, using the one or more scrambling codes, on one or more PDCCH MU-MIMO communications carried in one or more first CCEs that at least partially overlap with one or more second CCEs associated with the one or more candidate UEs. The means for the network node 110 to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

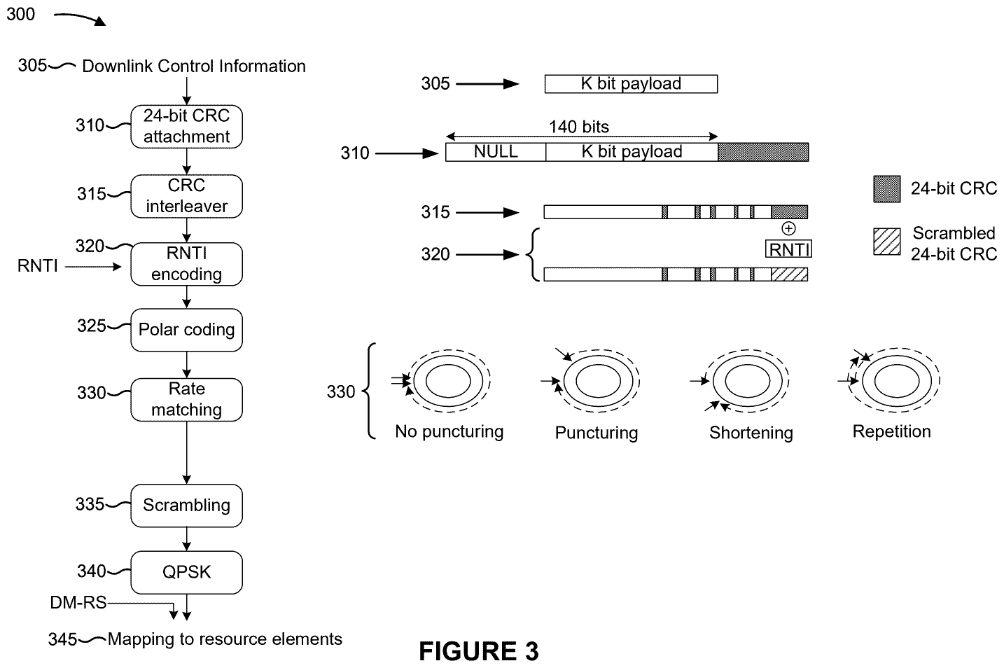

FIG. 3 is a diagram illustrating an example 300 associated with PDCCH processing.

At a first operation 305, the network node 110 may identify DCI for transmission on a PDCCH. For example, as shown, the DCI may comprise a K-bit payload.

At a second operation 310, the network node 110 may attach 24-bit cyclic redundancy check (CRC) code to the DCI. For example, as shown, the network node 110 may attach the 24-bit CRC code to the K-bit payload.

At a third operation 315, the network node 110 may interleave the 24-bit CRC code with the DCI.

At a fourth operation 320, the network node 110 may perform radio network temporary identifier (RNTI) encoding. For example, the network node 110 may use an RNTI to scramble the 24-bit CRC code.

At a fifth operation 325, the network node 110 may perform polar coding. Polar coding may involve identifying subchannels that are either substantially noiseless or substantially completely noisy. The substantially noiseless subchannels may carry information bits of a PDCCH communication comprising the 24-bit CRC code and DCI.

At a sixth operation 330, the network node 110 may perform rate-matching. For example, as shown, the network node 110 may match coded bits of the PDCCH communication to resources available for PDCCH transmission using no puncturing, puncturing, shortening, or repetition of the coded bits.

At a seventh operation 335, the network node 110 may scramble the rate-matched bits. “Scrambling” may refer to introducing randomness to the rate-matched bits, thereby helping to distribute power uniformly, manage interference, ensure data privacy, and/or enable accurate channel estimation. In some examples, the network node 110 may scramble the rate-matched bits using a scrambling code. For example, the network node 110 may perform a bitwise exclusive-or (XOR) operation on the rate-matched bits using the scrambling code. The scrambling code may be a cell-specific bit sequence that is identified based at least in part on a cell identifier (for example, a C-RNTI) and/or a scrambling identity.

At an eighth operation 340, the network node 110 may modulate the scrambled bits using quadrature phase shift keying (QPSK).

At a ninth operation 345, the network node 110 may map the modulated bits to one or more resource elements (REs). As shown, the network node 110 may also map, to the one or more REs, a DMRS corresponding to the PDCCH.

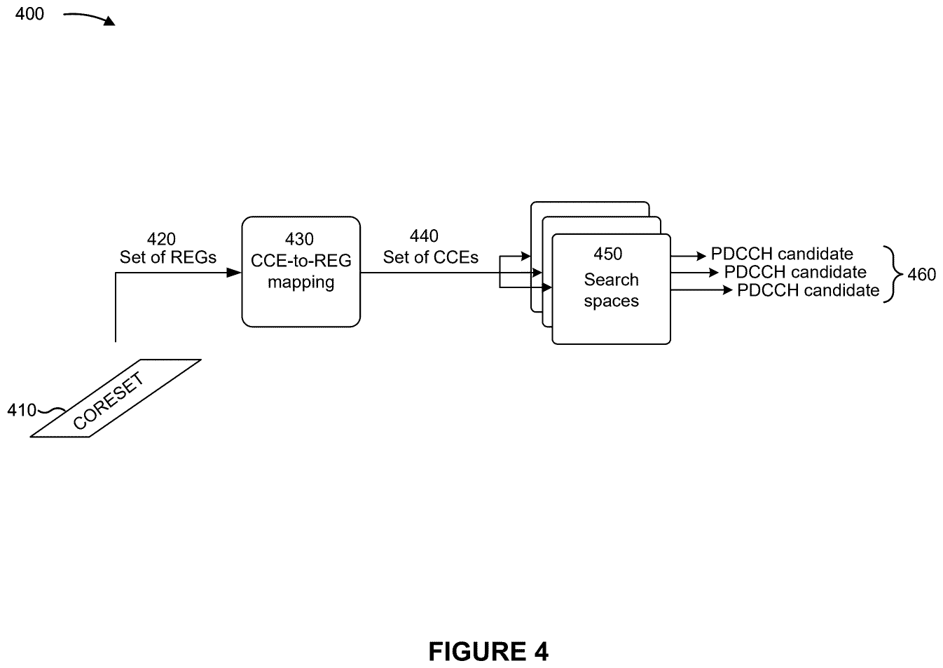

FIG. 4 is a diagram illustrating an example 400 associated with CORESETs.

In some examples, the PDCCH communication may be transmitted in time-frequency resources of a CORESET 410. For example, the CORESET 410 may include a set of REGs 420 and may be associated with a mapping 430 between the set of REGs 420 and a set of CCEs 440. The mapping 430 may be referred to as a CCE-to-REG mapping. In some examples, an REG is equal to one resource block (RB) (for example, 12 REs in the frequency domain) and one OFDM symbol in the time domain.

In some examples, the network node 110 may transmit the PDCCH communication using a quantity of contiguous CCEs (for example, 1, 2, 4, 8, or 16 CCEs). The quantity of contiguous CCEs is referred to as an aggregation level of the PDCCH communication. The set of CCEs 440 may form search spaces 450, corresponding to respective aggregation levels, in which a UE 120 may attempt to decode the PDCCH communication. For example, the UE 120 may perform blind decoding in PDCCH candidates 460 of the search spaces 450. The PDCCH candidates 460 may comprise one or more CCEs of the set of CCEs 440.

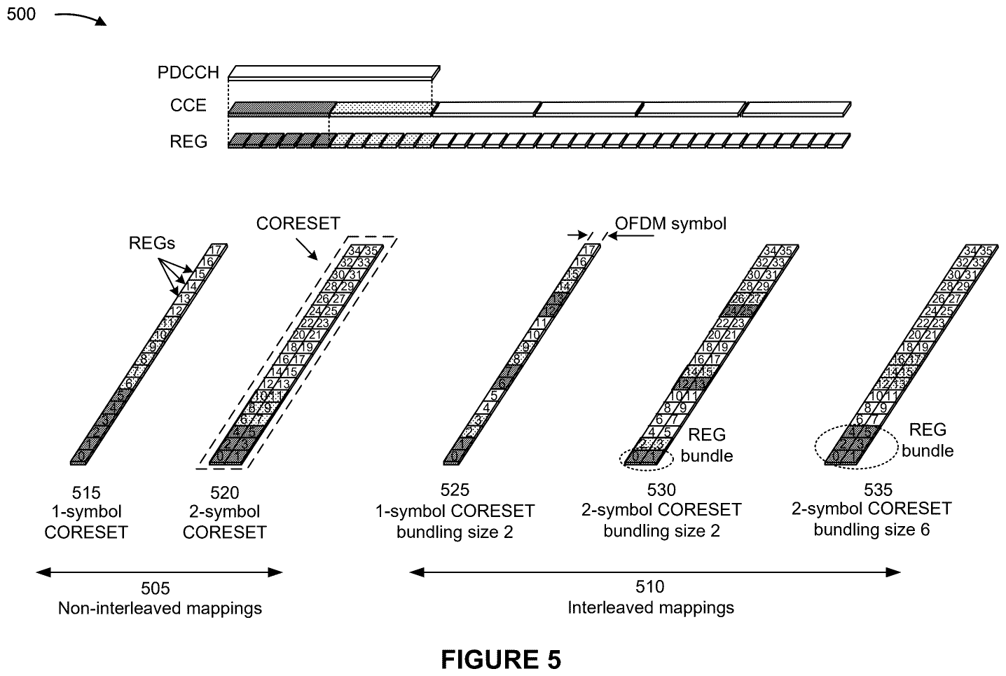

FIG. 5 is a diagram illustrating examples 500 associated with CCE-to-REG mappings.

As shown in example 500, six consecutive REGs form one CCE, and one or more CCEs form a PDCCH. Example 500 further shows non-interleaved CCE-to-REG mappings 505 and interleaved CCE-to-REG mappings 510. Non-interleaved CCE-to-REG mappings 505 and interleaved CCE-to-REG mappings 510 involve REG bundles, which are sets of REGs across which precoding can be treated as constant. The UE 120 may exploit this property of constant precoding to improve the performance of channel estimation by the UE 120 (for example, similarly to scenarios involving RB bundling for PDSCH).

As shown, non-interleaved CCE-to-REG mappings 505 may be associated with a 1-symbol CORESET 515 or a 2-symbol CORESET 520, among other examples. For non-interleaved CCE-to-REG mappings 505, the REG bundle size is six REGs. Thus, the UE 120 may assume that the precoding is constant across an entire CCE.

Interleaved CCE-to-REG mappings 510 may be configurable between REG bundle sizes of two, three, or six REGs. For interleaved CCE-to-REG mappings having a duration of one or two symbols, the bundle size may be two or six REGs, and for interleaved CCE-to-REG mappings having a duration of three OFDM symbols, the bundle size may be three or six REGs. For example, interleaved CCE-to-REG mappings 510 may be associated with a 1-symbol CORESET 525 with a REG bundle size of two REGs, a 2-symbol CORESET 530 with a REG bundle size of two REGs, or a 2-symbol CORESET 535 with a REG bundle size of six REGs, among other examples. The REG bundles may be obtained using a block interleaver.

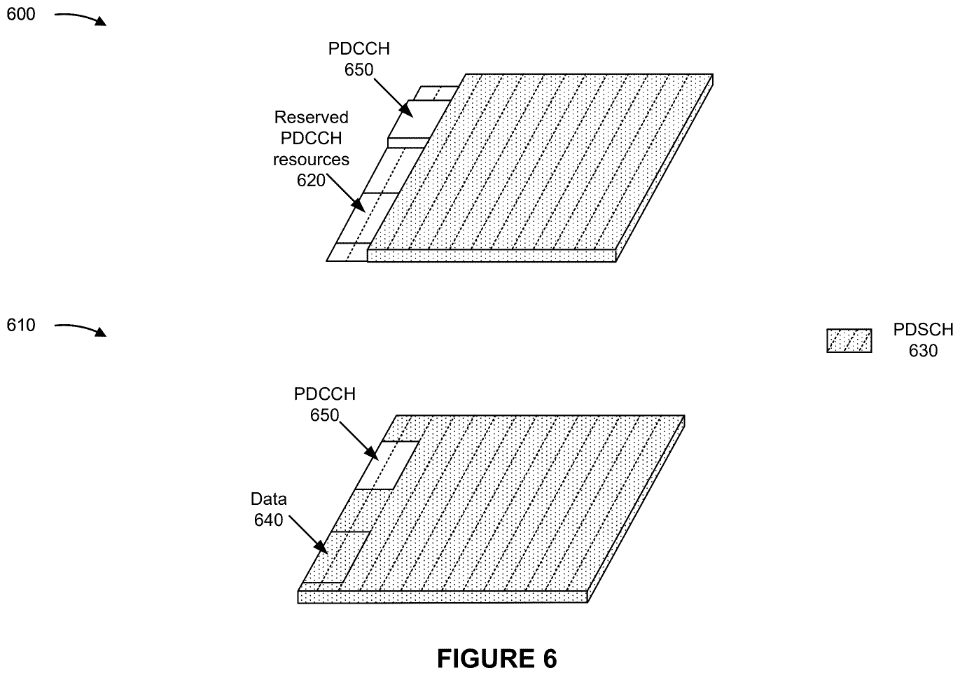

FIG. 6 is a diagram illustrating examples 600 and 610 associated with PDCCH rate-matching.

In some examples, the network node 110 may configure the UE 120 with resources, such as PDCCH resources, that overlap with a CORESET. The network node 110 may transmit, and the UE 120 may receive, DCI indicating whether or not the resources are reserved. If the DCI indicates that the resources are reserved, then the PDSCH may be rate-matched around the reserved resources overlapping with the CORESET.

In some examples, the DCI may also indicate whether or not the reserved resources are usable (or available) for a PDSCH. In example 600, the DCI indicates that reserved PDCCH resources 620 are not usable for PDSCH 630. In example 610, the DCI indicates that the reserved PDCCH resources 620 are usable for the PDSCH 630, and the PDSCH 630 may use the reserved PDCCH resources 620 for data 640 is scheduled on the reserved PDCCH resources 620. In both examples 600 and 610, data is not scheduled on resources that are used by a PDCCH 650 and on which the UE 120 received DCI scheduling the PDSCH 630.

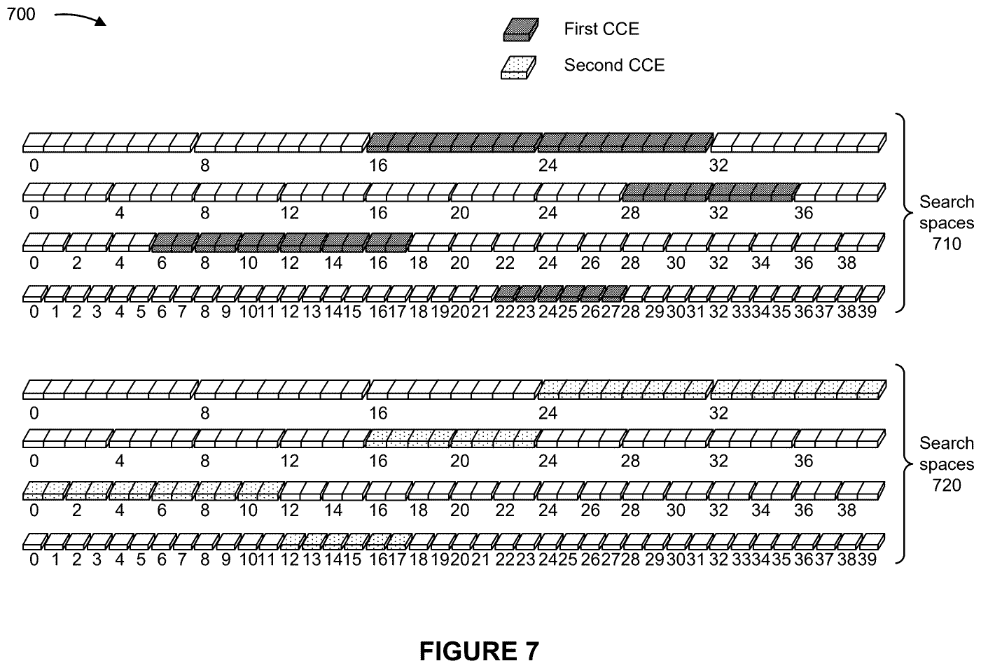

FIG. 7 is a diagram illustrating an example 700 associated with search spaces for respective UEs.

In MU-MIMO use cases, the UE 120a may perform blind decoding in search spaces 710, and the UE 120b may simultaneously perform blind decoding in search spaces 720. Search spaces 710 and 720 each include four search spaces corresponding to aggregation levels 1, 2, 4, and 8, respectively. As shown, the UEs 120a and 120b may block CCEs used for blind decoding by the other. For example, because CCEs 16-23 are the only CCEs available for UE 120b to perform blind decoding in aggregation level 4, if the UE 120a uses CCEs 16-23, then the network node 110 may be unable to transmit a PDCCH communication to the UE 120b on aggregation level 4.

As a result, in examples where the same CCEs are used for multiple UEs, occurrences of missing PDCCHs increase, leading to significant PDCCH blocking issues and suboptimal CCE allocation. In hot spots during high-traffic time windows, physical RB (PRB) usage for a physical downlink channel (PDXCH), such as a PDCCH or PDSCH, among other examples, may be 20-30%. Furthermore, because a UE uses a single antenna port for receiving PDCCH communications, MU-MIMO is transparent to UEs, and the UEs are unable to use inter-UE IC to improve CCE usage.

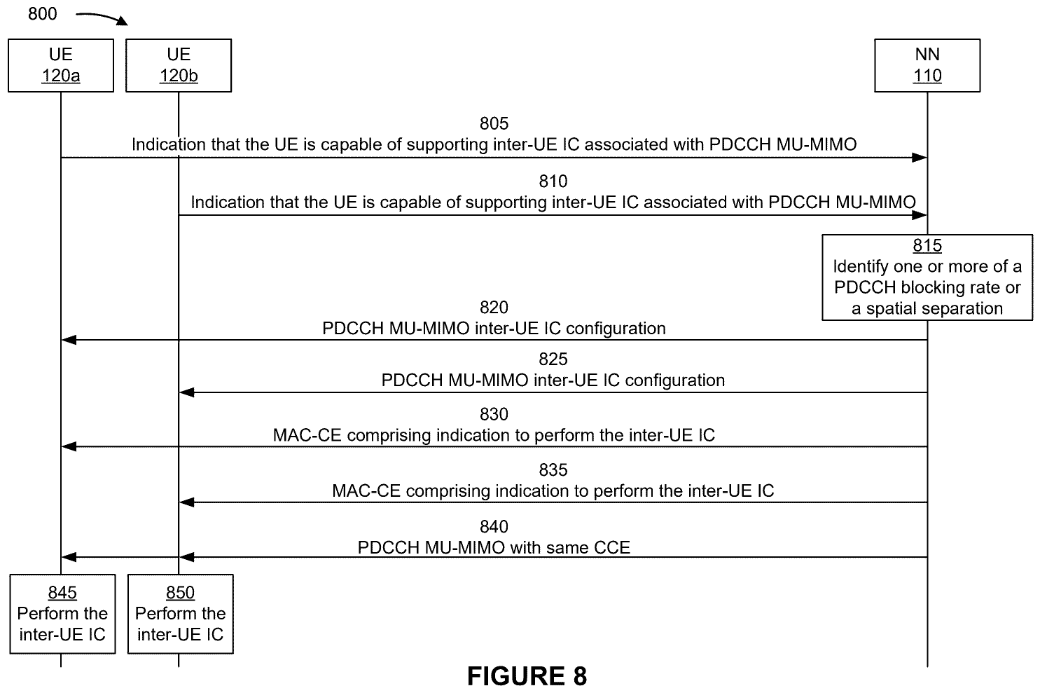

FIG. 8 is a diagram illustrating an example 800 associated with inter-UE IC for PDCCH MU-MIMO, in accordance with the present disclosure. As shown in FIG. 8, a UE 120a, a UE 120b, and a network node 110 may communicate with one another.

At a first operation 805, the UE 120a may transmit, and the network node 110 may receive, an indication that the UE 120a is capable of supporting inter-UE IC associated with PDCCH MU-MIMO. The inter-UE IC may be associated with PDCCH MU-MIMO in that the UE 120a may perform inter-UE IC on one or more PDCCH MU-MIMO communications. For example, the UE 120a may indicate a capability to support inter-UE IC for PDCCH MU-MIMO.

At a second operation 810, the UE 120b may transmit, and the network node 110 may receive, an indication that the UE 120b is capable of supporting inter-UE IC associated with PDCCH MU-MIMO. The indication that the UE 120b is capable of supporting inter-UE IC associated with PDCCH MU-MIMO may be similar to the indication that the UE 120a is capable of supporting inter-UE IC associated with PDCCH MU-MIMO, but may apply to the UE 120b rather than the UE 120a.

At a third operation 815, the network node 110 may identify one or more of a PDCCH blocking rate associated with CCE usage or a spatial separation between the UE 120a and the UE 120b. The PDCCH blocking rate may be associated with CCE usage in that the PDCCH blocking rate may be due to the CCE usage. For example, the PDCCH blocking rate may be a percentage of PDCCH blocking, and the CCE usage may be a lack of CCEs. The PDCCH blocking rate and/or the spatial separation may be examples of UE pairing conditions (for example, condition for pairing the UE 120a and the UE 120b for purposes of the inter-UE IC). For example, the network node 110 may identify whether to use PDCCH MU-MIMO based at least in part on the PDCCH blocking rate and/or the spatial separation.

At a fourth operation 820, the network node 110 may transmit, and the UE 120a may receive, a PDCCH MU-MIMO inter-UE IC configuration in accordance with the indication that the UE 120a is capable of supporting the inter-UE IC. For example, the network node 110 may transmit, and the UE 120a may receive, the PDCCH MU-MIMO inter-UE IC configuration responsive to the indication that the UE 120a is capable of supporting the inter-UE IC. The PDCCH MU-MIMO inter-UE IC configuration may enable and/or configure the UE 120a for the inter-UE IC (for example, inter-UE IC for PDCCH MU-MIMO). In some examples, the PDCCH MU-MIMO inter-UE IC configuration may be an RRC configuration or reconfiguration. For example, the network node 110 may configure PDCCH MU-MIMO via the RRC reconfiguration.

In some aspects, the network node 110 may transmit, and the UE 120a may receive, the PDCCH MU-MIMO inter-UE IC configuration in accordance with the PDCCH blocking rate associated with CCE usage. For example, the network node 110 may transmit, and the UE 120a may receive, the PDCCH MU-MIMO inter-UE IC configuration responsive to the PDCCH blocking rate satisfying (for example, exceeding) a PDCCH blocking rate threshold.

In some aspects, the network node 110 may transmit, and the UE 120a may receive, the PDCCH MU-MIMO inter-UE IC configuration in accordance with one or more spatial separations between the UE and the one or more candidate UEs. For example, the network node 110 may transmit, and the UE 120a may receive, the PDCCH MU-MIMO inter-UE IC configuration in accordance with a spatial separation (for example, a distance) between the UE 120a and the UE 120b. For example, the network node 110 may transmit, and the UE 120a may receive, the PDCCH MU-MIMO inter-UE IC configuration responsive to the spatial separation between the UE 120a and the UE 120b being less than a spatial separation threshold.

In some aspects, the PDCCH MU-MIMO inter-UE IC configuration may include an indication of one or more scrambling codes corresponding to one or more candidate UEs of PDCCH MU-MIMO. For example, the one or more candidate UEs may include the UE 120b. In some aspects, the indication of the one or more scrambling codes may comprise an indication of a plurality of scrambling codes. For example, each scrambling code may correspond to a different candidate UE, one of which may be the UE 120b. A total quantity of the plurality of scrambling codes may be a maximum quantity of candidate UEs for PDCCH MU-MIMO.

In some aspects, the indication of the one or more scrambling codes may comprise one or more of an indication of one or more C-RNTIs or an indication of one or more scrambling code identities. For example, as discussed above in connection with FIG. 3, a scrambling code may be identified based at least in part on a C-RNTI and/or a scrambling identity. In some aspects, the PDCCH MU-MIMO inter-UE IC configuration may further include an indication of one or more indexes corresponding to the one or more C-RNTIs or the one or more scrambling code identities. For example, the indexes may correspond to respective C-RNTIs or scrambling code identities. Each index may represent a different candidate UE for PDCCH MU-MIMO using a C-RNTI and/or a scrambling code identity.

In some aspects, the PDCCH MU-MIMO inter-UE IC configuration may further include an indication of one or more REG bundle sizes corresponding to the one or more candidate UEs. For example, as discussed above in connection with FIG. 5, a UE may be configured with a REG bundle size. The PDCCH MU-MIMO inter-UE IC configuration may indicate the REG bundle sizes configured on the candidate UEs.

In some aspects, the PDCCH MU-MIMO inter-UE IC configuration may further include an indication of whether each of the one or more candidate UEs is associated with an interleaved CCE-to-REG mapping or a non-interleaved CCE-to-REG mapping. For example, as discussed above in connection with FIG. 4, a UE may be configured with a CCE-to-REG mapping, and as discussed above in connection with FIG. 5, the CCE-to-REG mapping may be interleaved or non-interleaved. The PDCCH MU-MIMO inter-UE IC configuration may indicate whether the candidate UEs are configured with interleaved CCE-to-REG mappings or non-interleaved CCE-to-REG mapping.

In some aspects, the PDCCH MU-MIMO inter-UE IC configuration may further include an indication of whether each of the one or more candidate UEs is associated with PDCCH rate-matching with a PDSCH. For example, as discussed above in connection with FIG. 6, a UE may be configured to perform PDCCH rate-matching with a PDSCH. The PDCCH MU-MIMO inter-UE IC configuration may indicate whether the candidate UEs are configured with the PDCCH rate-matching.

At a fifth operation 825, the network node 110 may transmit, and the UE 120b may receive, a PDCCH MU-MIMO inter-UE IC configuration in accordance with the indication that the UE 120b is capable of supporting the inter-UE IC. The PDCCH MU-MIMO inter-UE IC configuration of the UE 120b may be similar to the PDCCH MU-MIMO inter-UE IC configuration of the UE 120a, but may apply to the UE 120b rather than the UE 120a. For example, the PDCCH MU-MIMO inter-UE IC configuration of the UE 120b may include an indication of one or more scrambling codes corresponding to one or more candidate UEs, including the UE 120a, of PDCCH MU-MIMO. That is, the UE 120a and the UE 120b may be candidate UEs for each other.

Table 1 below shows an example PDCCH MU-MIMO inter-UE IC configuration including, for each candidate UE, an index, a C-RNTI, a scrambling code identity, a REG bundle size, an indication of whether a CCE-to-REG mapping is interleaved, and an indication of whether PDCCH rate matching is supported. The example of Table 1 includes a total of five candidate UEs.

TABLE 1

| | | | | | PDCCH |
|---|---|---|---|---|---|
| | C- | Scrambling | REG bundle | | rate |
| Index | RNTI | code identity | size | Interleaved | match |
| 0 | aaaaa | fffff | 2, 3 or full | Y/N | Y/N |
| 1 | bbbbb | ggggg | 2, 3 or full | Y/N | Y/N |
| 2 | ccccc | hhhhh | 2, 3 or full | Y/N | Y/N |
| 3 | ddddd | iiiii | 2, 3 or full | Y/N | Y/N |
| 4 | eeeee | jjjjj | 2, 3 or full | Y/N | Y/N |

In some aspects, the network node 110 may transmit, and the UE 120a may receive, an indication to perform the inter-UE IC, using the one or more scrambling codes, on one or more PDCCH MU-MIMO communications carried in one or more first CCEs that at least partially overlap with one or more second CCEs associated with the one or more candidate UEs. For example, as discussed above in connection with FIG. 7, a UE may be configured with one or more CCEs. The UE 120a may be configured with the one or more first CCEs, and the UE 120b may be configured with the one or more second CCEs. The first and second CCEs may be the same CCEs (for example, the first and second CCEs may fully overlap), or the first and second CCEs may partially overlap.

In some aspects, the indication to perform the inter-UE IC on the one or more PDCCH MU-MIMO communications using the one or more scrambling codes may comprise a bitmap that includes a bit corresponding to the one or more scrambling codes. For example, the bitmap may indicate one or more indexes of one or more of the candidate UEs corresponding to one or more C-RNTIs or scrambling codes for a multi-user PDCCH (MU-PDCCH) pairing. For example, a bitmap of 01001 indicates that multiple user (MU) UEs (for example, the candidate UEs corresponding to index 1 and index 4) are selected (for example, “paired”) to the UE 120a for PDCCH MU-MIMO. The UE 120a may identify the C-RNTIs and/or scrambling code identities of the selected candidate UEs based at least in part on the PDCCH MU-MIMO inter-UE IC configuration.

In some aspects, the indication to perform the inter-UE IC on the one or more PDCCH MU-MIMO communications may comprise a MAC-CE in a PDSCH communication. For example, at a sixth operation 830, the network node 110 may transmit, and the UE 120a may receive, the MAC-CE. The network node 110 may transmit, and the UE 120a may receive, the MAC-CE in a PDSCH or a PDCCH. In some examples, the MAC-CE may carry the bitmap. For example, the MAC-CE may select one or more of the candidate UEs for PDCCH MU-MIMO by identifying the indexes corresponding to the C-RNTIs and/or scrambling code identities of the selected candidate UEs.

In some aspects, the network node 110 may transmit, and the UE 120b may receive, an indication to perform the inter-UE IC, using the one or more scrambling codes, on the one or more PDCCH MU-MIMO communications. For example, at a seventh operation 835, the network node 110 may transmit, and the UE 120b may receive, a MAC-CE comprising the indication to perform the inter-UE IC. The indication to perform the inter-UE IC for the UE 120b may be similar to the indication to perform the inter-UE IC for the UE 120a, but may apply to the UE 120b rather than the UE 120a.

At an eighth operation 840, the network node 110 may transmit, and the UEs 120a and 120b may receive, the one or more PDCCH MU-MIMO communications. The one or more PDCCH MU-MIMO communications may be carried in the one or more first CCEs that may at least partially overlap with one or more second CCEs. In some aspects, the MAC-CE(s) may be carried in a first slot, and the network node 110 may transmit, and the UEs 120a and 120b may receive, the one or more PDCCH MU-MIMO communications in one or more second slots that occur after the first slot. For example, the MAC-CE(s) may indicate the selected candidate UEs using a bitmap for the one or more second slots that have the same or different PDCCH MU-MIMO as the first slot.

In some aspects (for example, alternatively to the sixth operation 830 and the seventh operation 835), the indication to perform the inter-UE IC on the one or more PDCCH MU-MIMO communications may comprise DCI. In some examples, the DCI may carry the bitmap. The DCI may comprise the one or more PDCCH MU-MIMO communications. In some examples, the DCI may select one or more of the candidate UEs for PDCCH MU-MIMO by identifying the indexes corresponding to the C-RNTIs and/or scrambling code identities of the selected candidate UEs.

In some aspects, a first part of the DCI indicates a bitmap that includes a bit corresponding to the one or more scrambling codes. For example, the first part of the DCI may comprise a first part of the one or more PDCCH MU-MIMO communications. The first part of the DCI may indicate, using the index, a quantity of MU UEs, of the candidate UEs, that are selected for MU-MIMO PDCCH. In some examples, the network node 110 may transmit the first part of the DCI with a low coding rate, and the UE 120a and/or the UE 120b may decode the first part of the DCI at the low coding rate, which may help to increase reliability.

In some aspects, a second part of the DCI may indicate one or more of a radio resource allocation associated with a PDSCH of the UE 120a and/or the UE 120b, an MCS associated with the PDSCH, a MIMO layer associated with the PDSCH, or hybrid automatic repeat request (HARQ) information associated with the PDSCH. For example, the second part of the DCI may comprise a second part of the one or more PDCCH MU-MIMO communications. The second part of the DCI may occur after the first part of the DCI. In some examples, the second part of the DCI may carry a DCI payload that includes the radio resource allocation, the MCS, the MIMO layer, or the HARQ information, among other examples. The radio resource allocation may include a frequency domain resource allocation (FDRA) or a time domain resource allocation (TDRA), among other examples. The HARQ information may include a HARQ identifier or a HARQ redundancy value (RV) among other examples.

At a ninth operation 845, the UE 120a may perform the inter-UE IC. In some examples, the UE 120a may perform the inter-UE IC by decoding the PDCCH targeted for one or more selected UEs (for example, the UE 120b) and subtracting the decoded PDCCH from at least a part of the one or more PDCCH MU-MIMO communications such that the remaining signal includes data targeted for the UE 120a. In some examples, the UE 120a may perform the inter-UE IC using information provided in the PDCCH MU-MIMO inter-UE IC configuration, such as the C-RNTIs and/or scrambling code identities, to perform inter-UE IC for MU-MIMO PDCCH with at least partially overlapping CCEs. For example, the UE 120a may use one or more indexes in the PDCCH MU-MIMO inter-UE IC configuration to identify the C-RNTIs and/or scrambling code identities to decode PDCCH associated with candidate MU-PDCCH pairings with at least partially overlapping CCEs. In some examples, the UE 120a may perform the inter-UE IC to decode the PDCCH based at least in part on the MAC-CE and/or may decode the second part of the DCI that carries the DCI payload based at least in part on the first part of the DCI. In some examples, the UE 120a may use one or more of the REG bundle size, whether the REGs are interleaved, and/or whether PDCCH rate-matching between the PDCCH and the PDSCH for MU PDCCH is supported to perform the inter-UE IC.

At a tenth operation 850, the UE 120b may perform the inter-UE IC. The UE 120b may perform the inter-UE IC similarly to the indication to the UE 120a performing the inter-UE IC, but may apply to the UE 120b rather than the UE 120a. For example, the UE 120b may perform the inter-UE IC by decoding the PDCCH targeted for one or more selected UEs (for example, the UE 120a) and subtracting the decoded PDCCH from at least a part of the one or more PDCCH MU-MIMO communications such that the remaining signal includes data targeted for the UE 120b.

The PDCCH MU-MIMO inter-UE IC configuration may help to enhance PDCCH MU-MIMO by alleviating PDCCH blocking and improving CCE usage. For example, inter-UE IC for PDCCH MU-MIMO may help to decrease the quantity of missing PDCCHs in examples where at least part of a CCE is used for multiple UEs.

The PDCCH MU-MIMO inter-UE IC configuration further including the indication of the one or more REG bundle sizes may help to further improve the inter-UE IC.

The PDCCH MU-MIMO inter-UE IC configuration further including the indication of whether each of the one or more candidate UEs is associated with an interleaved CCE-to-REG mapping or a non-interleaved CCE-to-REG mapping may help to further improve the inter-UE IC.

The PDCCH MU-MIMO inter-UE IC configuration further including the indication of whether each of the one or more candidate UEs is associated with PDCCH rate-matching with the PDSCH may enable the UE 120a (for example) to perform the inter-UE IC on both PDCCH and PDSCH.

The indication to perform the inter-UE IC comprising the MAC-CE may help to enable implementation of PDCCH MU-MIMO inter-UE IC.

The indication to perform the inter-UE IC comprising DCI may enable the UE 120a (for example) to perform the inter-UE IC in the same slot in which the DCI is transmitted.

FIG. 9 is a flowchart illustrating an example process 900 performed, for example, at a UE or an apparatus of a UE that supports inter-UE IC for PDCCH MU-MIMO. Example process 900 is an example where the apparatus or the UE (for example, UE 120) performs operations associated with inter-UE IC for PDCCH MU-MIMO.

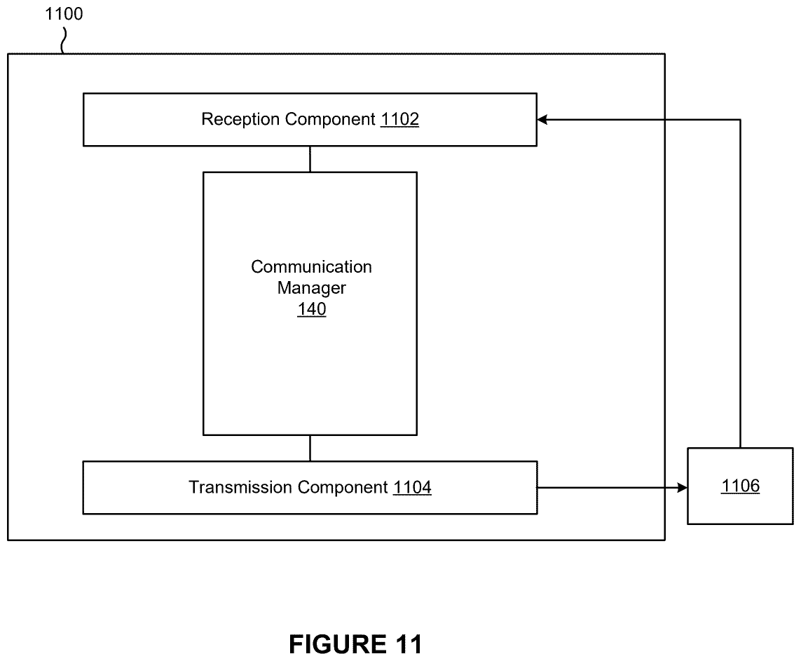

As shown in FIG. 9, in some aspects, process 900 may include transmitting an indication that the UE is capable of supporting inter-UE IC associated with PDCCH MU-MIMO (block 910). For example, the UE (such as by using communication manager 140 or transmission component 1104, depicted in FIG. 11) may transmit an indication that the UE is capable of supporting inter-UE IC associated with PDCCH MU-MIMO, as described above.

As further shown in FIG. 9, in some aspects, process 900 may include receiving, in accordance with the indication that the UE is capable of supporting the inter-UE IC, a PDCCH MU-MIMO inter-UE IC configuration including an indication of one or more scrambling codes corresponding to one or more candidate UEs of PDCCH MU-MIMO (block 920). For example, the UE (such as by using communication manager 140 or reception component 1102, depicted in FIG. 11) may receive, in accordance with the indication that the UE is capable of supporting the inter-UE IC, a PDCCH MU-MIMO inter-UE IC configuration including an indication of one or more scrambling codes corresponding to one or more candidate UEs of PDCCH MU-MIMO, as described above.

As further shown in FIG. 9, in some aspects, process 900 may include receiving an indication to perform the inter-UE IC, using the one or more scrambling codes, on one or more PDCCH MU-MIMO communications carried in one or more first CCEs that at least partially overlap with one or more second CCEs associated with the one or more candidate UEs (block 930). For example, the UE (such as by using communication manager 140 or reception component 1102, depicted in FIG. 11) may receive an indication to perform the inter-UE IC, using the one or more scrambling codes, on one or more PDCCH MU-MIMO communications carried in one or more first CCEs that at least partially overlap with one or more second CCEs associated with the one or more candidate UEs, as described above.

Process 900 may include additional aspects, such as any single aspect or any combination of aspects described below or in connection with one or more other processes described elsewhere herein.

In a first additional aspect, the indication of the one or more scrambling codes comprises an indication of a plurality of scrambling codes.

In a second additional aspect, alone or in combination with the first aspect, the indication of the one or more scrambling codes comprises one or more of an indication of one or more C-RNTIs or an indication of one or more scrambling code identities.

In a third additional aspect, alone or in combination with one or more of the first and second aspects, the PDCCH MU-MIMO inter-UE IC configuration further includes an indication of one or more indexes corresponding to the one or more C-RNTIs or the one or more scrambling code identities.

In a fourth additional aspect, alone or in combination with one or more of the first through third aspects, the PDCCH MU-MIMO inter-UE IC configuration further includes an indication of one or more REG bundle sizes corresponding to the one or more candidate UEs.

In a fifth additional aspect, alone or in combination with one or more of the first through fourth aspects, the PDCCH MU-MIMO inter-UE IC configuration further includes an indication of whether each of the one or more candidate UEs is associated with an interleaved CCE-to-REG mapping or a non-interleaved CCE-to-REG mapping.

In a sixth additional aspect, alone or in combination with one or more of the first through fifth aspects, the PDCCH MU-MIMO inter-UE IC configuration further includes an indication of whether each of the one or more candidate UEs is associated with PDCCH rate-matching with a PDSCH.

In a seventh additional aspect, alone or in combination with one or more of the first through sixth aspects, receiving the PDCCH MU-MIMO inter-UE IC configuration includes receiving the PDCCH MU-MIMO inter-UE IC configuration in accordance with a PDCCH blocking rate associated with CCE usage.

In an eighth additional aspect, alone or in combination with one or more of the first through seventh aspects, receiving the PDCCH MU-MIMO inter-UE IC configuration includes receiving the PDCCH MU-MIMO inter-UE IC configuration in accordance with one or more spatial separations between the UE and the one or more candidate UEs.

In a ninth additional aspect, alone or in combination with one or more of the first through eighth aspects, the indication to perform the inter-UE IC on the one or more PDCCH MU-MIMO communications using the one or more scrambling codes comprises a bitmap that includes a bit corresponding to the one or more scrambling codes.

In a tenth additional aspect, alone or in combination with one or more of the first through ninth aspects, the indication to perform the inter-UE IC on the one or more PDCCH MU-MIMO communications comprises a MAC-CE in a PDSCH communication.

In an eleventh additional aspect, alone or in combination with one or more of the first through tenth aspects, the MAC-CE is carried in a first slot, and process 900 includes receiving the one or more PDCCH MU-MIMO communications in one or more second slots that occur after the first slot.

In a twelfth additional aspect, alone or in combination with one or more of the first through eleventh aspects, the indication to perform the inter-UE IC on the one or more PDCCH MU-MIMO communications comprises DCI.

In a thirteenth additional aspect, alone or in combination with one or more of the first through twelfth aspects, a first part of the DCI indicates a bitmap that includes a bit corresponding to the one or more scrambling codes, and a second part of the DCI indicates one or more of a radio resource allocation associated with a PDSCH of the UE, an MCS associated with the PDSCH, a MIMO layer associated with the PDSCH, or HARQ information associated with the PDSCH.

Although FIG. 9 shows example blocks of process 900, in some aspects, process 900 may include additional blocks, fewer blocks, different blocks, or differently arranged blocks than those depicted in FIG. 9. Additionally or alternatively, two or more of the blocks of process 900 may be performed in parallel.

FIG. 10 is a flowchart illustrating an example process 1000 performed, for example, at a network node or an apparatus of a network node that supports inter-UE IC associated with PDCCH MU-MIMO. Example process 1000 is an example where the apparatus or the network node (for example, network node 110) performs operations associated with inter-UE IC for PDCCH MU-MIMO.

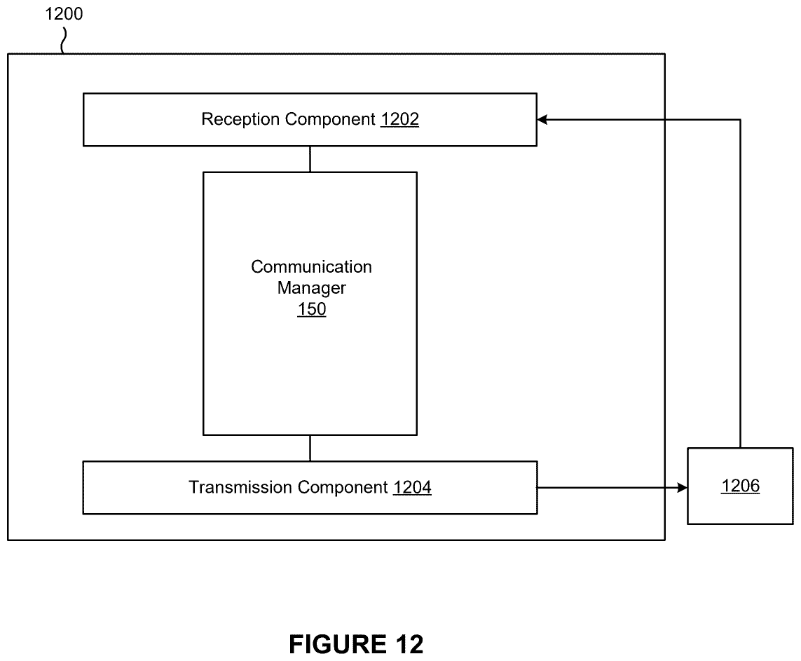

As shown in FIG. 10, in some aspects, process 1000 may include receiving an indication that the UE is capable of supporting inter-UE IC associated with PDCCH MU-MIMO (block 1010). For example, the network node (such as by using communication manager 150 or reception component 1202, depicted in FIG. 12) may receive an indication that the UE is capable of supporting inter-UE IC associated with PDCCH MU-MIMO, as described above.

As further shown in FIG. 10, in some aspects, process 1000 may include transmitting, in accordance with the indication that the UE is capable of supporting the inter-UE IC, a PDCCH MU-MIMO inter-UE IC configuration including an indication of one or more scrambling codes corresponding to one or more candidate UEs of PDCCH MU-MIMO (block 1020). For example, the network node (such as by using communication manager 150 or transmission component 1204, depicted in FIG. 12) may transmit, in accordance with the indication that the UE is capable of supporting the inter-UE IC, a PDCCH MU-MIMO inter-UE IC configuration including an indication of one or more scrambling codes corresponding to one or more candidate UEs of PDCCH MU-MIMO, as described above.

As further shown in FIG. 10, in some aspects, process 1000 may include transmitting an indication to perform the inter-UE IC, using the one or more scrambling codes, on one or more PDCCH MU-MIMO communications carried in one or more first CCEs that at least partially overlap with one or more second CCEs associated with the one or more candidate UEs (block 1030). For example, the network node (such as by using communication manager 150 or transmission component 1204, depicted in FIG. 12) may transmit an indication to perform the inter-UE IC, using the one or more scrambling codes, on one or more PDCCH MU-MIMO communications carried in one or more first CCEs that at least partially overlap with one or more second CCEs associated with the one or more candidate UEs, as described above.

Process 1000 may include additional aspects, such as any single aspect or any combination of aspects described below or in connection with one or more other processes described elsewhere herein.

In a first additional aspect, the indication of the one or more scrambling codes comprises an indication of a plurality of scrambling codes.

In a second additional aspect, alone or in combination with the first aspect, the indication of the one or more scrambling codes comprises one or more of an indication of one or more C-RNTIs or an indication of one or more scrambling code identities.

In a third additional aspect, alone or in combination with one or more of the first and second aspects, the PDCCH MU-MIMO inter-UE IC configuration further includes an indication of one or more indexes corresponding to the one or more C-RNTIs or the one or more scrambling code identities.

In a fourth additional aspect, alone or in combination with one or more of the first through third aspects, the PDCCH MU-MIMO inter-UE IC configuration further includes an indication of one or more REG bundle sizes corresponding to the one or more candidate UEs.

In a fifth additional aspect, alone or in combination with one or more of the first through fourth aspects, the PDCCH MU-MIMO inter-UE IC configuration further includes an indication of whether each of the one or more candidate UEs is associated with an interleaved CCE-to-REG mapping or a non-interleaved CCE-to-REG mapping.

In a sixth additional aspect, alone or in combination with one or more of the first through fifth aspects, the PDCCH MU-MIMO inter-UE IC configuration further includes an indication of whether each of the one or more candidate UEs is associated with PDCCH rate-matching with a PDSCH.

In a seventh additional aspect, alone or in combination with one or more of the first through sixth aspects, transmitting the PDCCH MU-MIMO inter-UE IC configuration includes transmitting the PDCCH MU-MIMO inter-UE IC configuration in accordance with a PDCCH blocking rate associated with CCE usage.

In an eighth additional aspect, alone or in combination with one or more of the first through seventh aspects, transmitting the PDCCH MU-MIMO inter-UE IC configuration includes transmitting the PDCCH MU-MIMO inter-UE IC configuration in accordance with one or more spatial separations between the UE and the one or more candidate UEs.

In a ninth additional aspect, alone or in combination with one or more of the first through eighth aspects, the indication to perform the inter-UE IC on the one or more PDCCH MU-MIMO communications using the one or more scrambling codes comprises a bitmap that includes a bit corresponding to the one or more scrambling codes.

In a tenth additional aspect, alone or in combination with one or more of the first through ninth aspects, the indication to perform the inter-UE IC on the one or more PDCCH MU-MIMO communications comprises a MAC-CE in a PDSCH communication.

In an eleventh additional aspect, alone or in combination with one or more of the first through tenth aspects, the MAC-CE is carried in a first slot, and the process 1000 includes transmitting the one or more PDCCH MU-MIMO communications in one or more second slots that occur after the first slot.

In a twelfth additional aspect, alone or in combination with one or more of the first through eleventh aspects, the indication to perform the inter-UE IC on the one or more PDCCH MU-MIMO communications comprises DCI.

In a thirteenth additional aspect, alone or in combination with one or more of the first through twelfth aspects, a first part of the DCI indicates a bitmap that includes a bit corresponding to the one or more scrambling codes, and a second part of the DCI indicates one or more of a radio resource allocation associated with a PDSCH of the UE, an MCS associated with the PDSCH, a MIMO layer associated with the PDSCH, or HARQ information associated with the PDSCH.

Although FIG. 10 shows example blocks of process 1000, in some aspects, process 1000 may include additional blocks, fewer blocks, different blocks, or differently arranged blocks than those depicted in FIG. 10. Additionally or alternatively, two or more of the blocks of process 1000 may be performed in parallel.

FIG. 11 is a diagram of an example apparatus 1100 for wireless communication that supports inter-UE IC associated with PDCCH MU-MIMO. The apparatus 1100 may be a UE, or a UE may include the apparatus 1100. In some aspects, the apparatus 1100 includes a reception component 1102, a transmission component 1104, and a communication manager 140, which may be in communication with one another (for example, via one or more buses). As shown, the apparatus 1100 may communicate with another apparatus 1106 (such as a UE, a network node, or another wireless communication device) using the reception component 1102 and the transmission component 1104.

In some aspects, the apparatus 1100 may be configured to and/or operable to perform one or more operations described herein in connection with FIG. 8.

Additionally or alternatively, the apparatus 1100 may be configured to and/or operable to perform one or more processes described herein, such as process 900 of FIG. 9. In some aspects, the apparatus 1100 may include one or more components of the UE described above in connection with FIG. 2.

The reception component 1102 may receive communications, such as reference signals, control information, and/or data communications, from the apparatus 1106. The reception component 1102 may provide received communications to one or more other components of the apparatus 1100, such as the communication manager 140. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1102 may include one or more antennas, one or more modems, one or more demodulators, one or more MIMO detectors, one or more receive processors, one or more controllers/processors, and/or one or more memories of the UE described above in connection with FIG. 2.

The transmission component 1104 may transmit communications, such as reference signals, control information, and/or data communications, to the apparatus 1106. In some aspects, the communication manager 140 may generate communications and may transmit the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, one or more modems, one or more modulators, one or more transmit MIMO processors, one or more transmit processors, one or more controllers/processors, and/or one or more memories of the UE described above in connection with FIG. 2. In some aspects, the transmission component 1104 may be co-located with the reception component 1102 in one or more transceivers.

The communication manager 140 may transmit or may cause the transmission component 1104 to transmit an indication that the UE is capable of supporting inter-UE IC associated with PDCCH MU-MIMO. The communication manager 140 may receive or may cause the reception component 1102 to receive, in accordance with the indication that the UE is capable of supporting the inter-UE IC, a PDCCH MU-MIMO inter-UE IC configuration including an indication of one or more scrambling codes corresponding to one or more candidate UEs of PDCCH MU-MIMO. The communication manager 140 may receive or may cause the reception component 1102 to receive an indication to perform the inter-UE IC, using the one or more scrambling codes, on one or more PDCCH MU-MIMO communications carried in one or more first CCEs that at least partially overlap with one or more second CCEs associated with the one or more candidate UEs. In some aspects, the communication manager 140 may perform one or more operations described elsewhere herein as being performed by one or more components of the communication manager 140. The communication manager 140 may include one or more controllers/processors and/or one or more memories of the UE described above in connection with FIG. 2.

The transmission component 1104 may transmit an indication that the UE is capable of supporting inter-UE IC associated with PDCCH MU-MIMO. The reception component 1102 may receive, in accordance with the indication that the UE is capable of supporting the inter-UE IC, a PDCCH MU-MIMO inter-UE IC configuration including an indication of one or more scrambling codes corresponding to one or more candidate UEs of PDCCH MU-MIMO. The reception component 1102 may receive an indication to perform the inter-UE IC, using the one or more scrambling codes, on one or more PDCCH MU-MIMO communications carried in one or more first CCEs that at least partially overlap with one or more second CCEs associated with the one or more candidate UEs.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally or alternatively, a set of (one or more) components shown in FIG. 11 may perform one or more functions described as being performed by another set of components shown in FIG. 11.

FIG. 12 is a diagram of an example apparatus 1200 for wireless communication that supports inter-UE IC associated with PDCCH MU-MIMO. The apparatus 1200 may be a network node, or a network node may include the apparatus 1200. In some aspects, the apparatus 1200 includes a reception component 1202, a transmission component 1204, and a communication manager 150, which may be in communication with one another (for example, via one or more buses). As shown, the apparatus 1200 may communicate with another apparatus 1206 (such as a UE, a network node, or another wireless communication device) using the reception component 1202 and the transmission component 1204.

In some aspects, the apparatus 1200 may be configured to and/or operable to perform one or more operations described herein in connection with FIG. 8. Additionally or alternatively, the apparatus 1200 may be configured to and/or operable to perform one or more processes described herein, such as process 1000 of FIG. 10. In some aspects, the apparatus 1200 may include one or more components of the network node described above in connection with FIG. 2.

The reception component 1202 may receive communications, such as reference signals, control information, and/or data communications, from the apparatus 1206. The reception component 1202 may provide received communications to one or more other components of the apparatus 1200, such as the communication manager 150. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1202 may include one or more antennas, one or more modems, one or more demodulators, one or more MIMO detectors, one or more receive processors, one or more controllers/processors, and/or one or more memories of the network node described above in connection with FIG. 2.

The transmission component 1204 may transmit communications, such as reference signals, control information, and/or data communications, to the apparatus 1206. In some aspects, the communication manager 150 may generate communications and may transmit the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, one or more modems, one or more modulators, one or more transmit MIMO processors, one or more transmit processors, one or more controllers/processors, and/or one or more memories of the network node described above in connection with FIG. 2. In some aspects, the transmission component 1204 may be co-located with the reception component 1202 in one or more transceivers.

The communication manager 150 may receive or may cause the reception component 1202 to receive an indication that the UE is capable of supporting inter-UE IC associated with PDCCH MU-MIMO. The communication manager 150 may transmit or may cause the transmission component 1204 to transmit, in accordance with the indication that the UE is capable of supporting the inter-UE IC, a PDCCH MU-MIMO inter-UE IC configuration including an indication of one or more scrambling codes corresponding to one or more candidate UEs of PDCCH MU-MIMO. The communication manager 150 may transmit or may cause the transmission component 1204 to transmit an indication to perform the inter-UE IC, using the one or more scrambling codes, on one or more PDCCH MU-MIMO communications carried in one or more first CCEs that at least partially overlap with one or more second CCEs associated with the one or more candidate UEs. In some aspects, the communication manager 150 may perform one or more operations described elsewhere herein as being performed by one or more components of the communication manager 150. The communication manager 150 may include one or more controllers/processors, one or more memories, one or more schedulers, and/or one or more communication units of the network node described above in connection with FIG. 2.

The transmission component 1204 may transmit an indication that the UE is capable of supporting inter-UE IC associated with PDCCH MU-MIMO. The reception component 1202 may receive, in accordance with the indication that the UE is capable of supporting the inter-UE IC, a PDCCH MU-MIMO inter-UE IC configuration including an indication of one or more scrambling codes corresponding to one or more candidate UEs of PDCCH MU-MIMO. The reception component 1202 may receive an indication to perform the inter-UE IC, using the one or more scrambling codes, on one or more PDCCH MU-MIMO communications carried in one or more first CCEs that at least partially overlap with one or more second CCEs associated with the one or more candidate UEs.

The reception component 1202 may receive an indication that the UE is capable of supporting inter-UE IC associated with PDCCH MU-MIMO. The transmission component 1204 may transmit, in accordance with the indication that the UE is capable of supporting the inter-UE IC, a PDCCH MU-MIMO inter-UE IC configuration including an indication of one or more scrambling codes corresponding to one or more candidate UEs of PDCCH MU-MIMO. The transmission component 1204 may transmit an indication to perform the inter-UE IC, using the one or more scrambling codes, on one or more PDCCH MU-MIMO communications carried in one or more first CCEs that at least partially overlap with one or more second CCEs associated with the one or more candidate UEs.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed at a user equipment (UE), comprising: transmitting an indication that the UE is capable of supporting inter-UE interference cancellation (inter-UE IC) associated with physical downlink control channel (PDCCH) multi-user multiple-input multiple-output (MU-MIMO); receiving, in accordance with the indication that the UE is capable of supporting the inter-UE IC, a PDCCH MU-MIMO inter-UE IC configuration including an indication of one or more scrambling codes corresponding to one or more candidate UEs of PDCCH MU-MIMO; and receiving an indication to perform the inter-UE IC, using the one or more scrambling codes, on one or more PDCCH MU-MIMO communications carried in one or more first control-channel elements (CCEs) that at least partially overlap with one or more second CCEs associated with the one or more candidate UEs.

Aspect 2: The method of Aspect 1, wherein the indication of the one or more scrambling codes comprises an indication of a plurality of scrambling codes.

Aspect 3: The method of any of Aspects 1-2, wherein the indication of the one or more scrambling codes comprises one or more of an indication of one or more cell radio network temporary identifiers (C-RNTIs) or an indication of one or more scrambling code identities.

Aspect 4: The method of Aspect 3, wherein the PDCCH MU-MIMO inter-UE IC configuration further includes an indication of one or more indexes corresponding to the one or more C-RNTIs or the one or more scrambling code identities.

Aspect 5: The method of any of Aspects 1-4, wherein the PDCCH MU-MIMO inter-UE IC configuration further includes an indication of one or more resource element group (REG) bundle sizes corresponding to the one or more candidate UEs.

Aspect 6: The method of any of Aspects 1-5, wherein the PDCCH MU-MIMO inter-UE IC configuration further includes an indication of whether each of the one or more candidate UEs is associated with an interleaved CCE-to-resource-element-group (CCE-to-REG) mapping or a non-interleaved CCE-to-REG mapping.

Aspect 7: The method of any of Aspects 1-6, wherein the PDCCH MU-MIMO inter-UE IC configuration further includes an indication of whether each of the one or more candidate UEs is associated with PDCCH rate-matching with a physical downlink shared channel (PDSCH).

Aspect 8: The method of any of Aspects 1-7, wherein receiving the PDCCH MU-MIMO inter-UE IC configuration includes receiving the PDCCH MU-MIMO inter-UE IC configuration in accordance with a PDCCH blocking rate associated with CCE usage.

Aspect 9: The method of any of Aspects 1-8, wherein receiving the PDCCH MU-MIMO inter-UE IC configuration includes receiving the PDCCH MU-MIMO inter-UE IC configuration in accordance with one or more spatial separations between the UE and the one or more candidate UEs.

Aspect 10: The method of any of Aspects 1-9, wherein the indication to perform the inter-UE IC on the one or more PDCCH MU-MIMO communications using the one or more scrambling codes comprises a bitmap that includes a bit corresponding to the one or more scrambling codes.

Aspect 11: The method of any of Aspects 1-10, wherein the indication to perform the inter-UE IC on the one or more PDCCH MU-MIMO communications comprises a medium access control (MAC) control element (MAC-CE) in a physical downlink shared channel (PDSCH) communication.

Aspect 12: The method of Aspect 11, wherein the MAC-CE is carried in a first slot, the method further comprising: receiving the one or more PDCCH MU-MIMO communications in one or more second slots that occur after the first slot.

Aspect 13: The method of any of Aspects 1-12, wherein the indication to perform the inter-UE IC on the one or more PDCCH MU-MIMO communications comprises downlink control information (DCI).

Aspect 14: The method of Aspect 13, wherein a first part of the DCI indicates a bitmap that includes a bit corresponding to the one or more scrambling codes, and a second part of the DCI indicates one or more of a radio resource allocation associated with a physical downlink shared channel (PDSCH) of the UE, a modulation and coding scheme (MCS) associated with the PDSCH, a multiple-input multiple-output (MIMO) layer associated with the PDSCH, or hybrid automatic repeat request (HARQ) information associated with the PDSCH.

Aspect 15: A method of wireless communication performed by a network node, comprising: receiving an indication that the UE is capable of supporting inter-UE interference cancellation (inter-UE IC) associated with physical downlink control channel (PDCCH) multi-user multiple-input multiple-output (MU-MIMO); transmitting, in accordance with the indication that the UE is capable of supporting the inter-UE IC, a PDCCH MU-MIMO inter-UE IC configuration including an indication of one or more scrambling codes corresponding to one or more candidate UEs of PDCCH MU-MIMO; and transmitting an indication to perform the inter-UE IC, using the one or more scrambling codes, on one or more PDCCH MU-MIMO communications carried in one or more first control-channel elements (CCEs) that at least partially overlap with one or more second CCEs associated with the one or more candidate UEs.

Aspect 16: The method of Aspect 15, wherein the indication of the one or more scrambling codes comprises an indication of a plurality of scrambling codes.

Aspect 17: The method of any of Aspects 15-16, wherein the indication of the one or more scrambling codes comprises one or more of an indication of one or more cell radio network temporary identifiers (C-RNTIs) or an indication of one or more scrambling code identities.

Aspect 18: The method of Aspect 17, wherein the PDCCH MU-MIMO inter-UE IC configuration further includes an indication of one or more indexes corresponding to the one or more C-RNTIs or the one or more scrambling code identities.

Aspect 19: The method of any of Aspects 15-18, wherein the PDCCH MU-MIMO inter-UE IC configuration further includes an indication of one or more resource element group (REG) bundle sizes corresponding to the one or more candidate UEs.

Aspect 20: The method of any of Aspects 15-19, wherein the PDCCH MU-MIMO inter-UE IC configuration further includes an indication of whether each of the one or more candidate UEs is associated with an interleaved CCE-to-resource-element-group (CCE-to-REG) mapping or a non-interleaved CCE-to-REG mapping.

Aspect 21: The method of any of Aspects 15-20, wherein the PDCCH MU-MIMO inter-UE IC configuration further includes an indication of whether each of the one or more candidate UEs is associated with PDCCH rate-matching with a physical downlink shared channel (PDSCH).

Aspect 22: The method of any of Aspects 15-21, wherein transmitting the PDCCH MU-MIMO inter-UE IC configuration includes transmitting the PDCCH MU-MIMO inter-UE IC configuration in accordance with a PDCCH blocking rate associated with CCE usage.

Aspect 23: The method of any of Aspects 15-22, wherein transmitting the PDCCH MU-MIMO inter-UE IC configuration includes transmitting the PDCCH MU-MIMO inter-UE IC configuration in accordance with one or more spatial separations between the UE and the one or more candidate UEs.

Aspect 24: The method of any of Aspects 15-23, wherein the indication to perform the inter-UE IC on the one or more PDCCH MU-MIMO communications using the one or more scrambling codes comprises a bitmap that includes a bit corresponding to the one or more scrambling codes.

Aspect 25: The method of any of Aspects 15-24, wherein the indication to perform the inter-UE IC on the one or more PDCCH MU-MIMO communications comprises a medium access control (MAC) control element (MAC-CE) in a physical downlink shared channel (PDSCH) communication.

Aspect 26: The method of Aspect 25, wherein the MAC-CE is carried in a first slot, the method further comprising: transmitting the one or more PDCCH MU-MIMO communications in one or more second slots that occur after the first slot.

Aspect 27: The method of any of Aspects 15-26, wherein the indication to perform the inter-UE IC on the one or more PDCCH MU-MIMO communications comprises downlink control information (DCI).

Aspect 28: The method of Aspect 27, wherein a first part of the DCI indicates a bitmap that includes a bit corresponding to the one or more scrambling codes, and a second part of the DCI indicates one or more of a radio resource allocation associated with a physical downlink shared channel (PDSCH) of the UE, a modulation and coding scheme (MCS) associated with the PDSCH, a multiple-input multiple-output (MIMO) layer associated with the PDSCH, or hybrid automatic repeat request (HARQ) information associated with the PDSCH.

Aspect 29: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-28.

Aspect 30: An apparatus for wireless communication at a device, the apparatus comprising one or more memories and one or more processors coupled to the one or more memories, the one or more processors configured to cause the device to perform the method of one or more of Aspects 1-28.

Aspect 31: An apparatus for wireless communication, the apparatus comprising at least one means for performing the method of one or more of Aspects 1-28.

Aspect 32: A non-transitory computer-readable medium storing code for wireless communication, the code comprising instructions executable by one or more processors to perform the method of one or more of Aspects 1-28.

Aspect 33: A non-transitory computer-readable medium storing a set of instructions for wireless communication, the set of instructions comprising one or more instructions that, when executed by one or more processors of a device, cause the device to perform the method of one or more of Aspects 1-28.

Aspect 34: A device for wireless communication, the device comprising a processing system that includes one or more processors and one or more memories coupled with the one or more processors, the processing system configured to cause the device to perform the method of one or more of Aspects 1-28.

Aspect 35: An apparatus for wireless communication at a device, the apparatus comprising one or more memories and one or more processors coupled to the one or more memories, the one or more processors individually or collectively configured to cause the device to perform the method of one or more of Aspects 1-28.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, the term “determine” or “determining” encompasses a wide variety of actions and, therefore, “determining” can include calculating, computing, processing, deriving, investigating, looking up (such as via looking up in a table, a database or another data structure), identifying, inferring, ascertaining, measuring, and the like. Also, “determining” can include receiving (such as receiving information or receiving an indication), accessing (such as accessing data stored in memory), transmitting (such as transmitting information) and the like. Also, “determining” can include resolving, selecting, obtaining, choosing, establishing and other such similar actions. The term “identify” or “identifying” also encompasses a wide variety of actions and, therefore, “identifying” can include calculating, computing, processing, deriving, investigating, looking up (such as via looking up in a table, a database or another data structure), inferring, ascertaining, measuring, and the like. Also, “identifying” can include receiving (such as receiving information or receiving an indication), accessing (such as accessing data stored in memory), transmitting (such as transmitting information) and the like. Also, “identifying” can include resolving, selecting, obtaining, choosing, establishing and other such similar actions.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, as used herein, “based on” is intended to be interpreted in the inclusive sense, unless otherwise explicitly indicated. For example, “based on” may be used interchangeably with “based at least in part on,” “associated with”, or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions or information. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories storing processor-executable code; and
one or more processors coupled with the one or more memories, at least one processor of the one or more processors configured to cause the UE to:
transmit an indication that the UE is capable of supporting inter-UE interference cancellation (inter-UE IC) associated with physical downlink control channel (PDCCH) multi-user multiple-input multiple-output (MU-MIMO);
receive, in accordance with the indication that the UE is capable of supporting the inter-UE IC, a PDCCH MU-MIMO inter-UE IC configuration including an indication of one or more scrambling codes corresponding to one or more candidate UEs of PDCCH MU-MIMO; and
receive an indication to perform the inter-UE IC, using the one or more scrambling codes, on one or more PDCCH MU-MIMO communications carried in one or more first control-channel elements (CCEs) that at least partially overlap with one or more second CCEs associated with the one or more candidate UEs.

2. The apparatus of claim 1, wherein the indication of the one or more scrambling codes comprises an indication of a plurality of scrambling codes.

3. The apparatus of claim 1, wherein the indication of the one or more scrambling codes comprises one or more of an indication of one or more cell radio network temporary identifiers (C-RNTIs) or an indication of one or more scrambling code identities.

4. The apparatus of claim 3, wherein the PDCCH MU-MIMO inter-UE IC configuration further includes an indication of one or more indexes corresponding to the one or more C-RNTIs or the one or more scrambling code identities.

5. The apparatus of claim 1, wherein the PDCCH MU-MIMO inter-UE IC configuration further includes an indication of one or more resource element group (REG) bundle sizes corresponding to the one or more candidate UEs.

6. The apparatus of claim 1, wherein the PDCCH MU-MIMO inter-UE IC configuration further includes an indication of whether each of the one or more candidate UEs is associated with an interleaved CCE-to-resource-element-group (CCE-to-REG) mapping or a non-interleaved CCE-to-REG mapping.

7. The apparatus of claim 1, wherein the PDCCH MU-MIMO inter-UE IC configuration further includes an indication of whether each of the one or more candidate UEs is associated with PDCCH rate-matching with a physical downlink shared channel (PDSCH).

8. An apparatus for wireless communication at a network node, comprising:
one or more memories storing processor-executable code; and
one or more processors coupled with the one or more memories, at least one processor of the one or more processors configured to cause the network node to:
receive an indication that a user equipment (UE) is capable of supporting inter-UE interference cancellation (inter-UE IC) associated with physical downlink control channel (PDCCH) multi-user multiple-input multiple-output (MU-MIMO);
transmit, in accordance with the indication that the UE is capable of supporting the inter-UE IC, a PDCCH MU-MIMO inter-UE IC configuration including an indication of one or more scrambling codes corresponding to one or more candidate UEs of PDCCH MU-MIMO; and
transmit an indication to perform the inter-UE IC, using the one or more scrambling codes, on one or more PDCCH MU-MIMO communications carried in one or more first control-channel elements (CCEs) that at least partially overlap with one or more second CCEs associated with the one or more candidate UEs.

9. The apparatus of claim 8, wherein the at least one processor, to cause the network node to transmit the PDCCH MU-MIMO inter-UE IC configuration, is configured to cause the network node to transmit the PDCCH MU-MIMO inter-UE IC configuration in accordance with a PDCCH blocking rate associated with CCE usage.

10. The apparatus of claim 8, wherein the at least one processor, to cause the network node to transmit the PDCCH MU-MIMO inter-UE IC configuration, is configured to cause the network node to transmit the PDCCH MU-MIMO inter-UE IC configuration in accordance with one or more spatial separations between the UE and the one or more candidate UEs.

11. The apparatus of claim 8, wherein the indication to perform the inter-UE IC on the one or more PDCCH MU-MIMO communications using the one or more scrambling codes comprises a bitmap that includes a bit corresponding to the one or more scrambling codes.

12. The apparatus of claim 8, wherein the indication to perform the inter-UE IC on the one or more PDCCH MU-MIMO communications comprises a medium access control (MAC) control element (MAC-CE) in a physical downlink shared channel (PDSCH) communication.

13. The apparatus of claim 12, wherein the MAC-CE is carried in a first slot, and wherein at least one processor of the one or more processors is configured to cause the network node to:
transmit the one or more PDCCH MU-MIMO communications in one or more second slots that occur after the first slot.

14. The apparatus of claim 8, wherein the indication to perform the inter-UE IC on the one or more PDCCH MU-MIMO communications comprises downlink control information (DCI).

15. The apparatus of claim 14, wherein a first part of the DCI indicates a bitmap that includes a bit corresponding to the one or more scrambling codes, and a second part of the DCI indicates one or more of a radio resource allocation associated with a physical downlink shared channel (PDSCH) of the UE, a modulation and coding scheme (MCS) associated with the PDSCH, a multiple-input multiple-output (MIMO) layer associated with the PDSCH, or hybrid automatic repeat request (HARQ) information associated with the PDSCH.

16. A method of wireless communication performed at a user equipment (UE), comprising:
transmitting an indication that the UE is capable of supporting inter-UE interference cancellation (inter-UE IC) associated with physical downlink control channel (PDCCH) multi-user multiple-input multiple-output (MU-MIMO);
receiving, in accordance with the indication that the UE is capable of supporting the inter-UE IC, a PDCCH MU-MIMO inter-UE IC configuration including an indication of one or more scrambling codes corresponding to one or more candidate UEs of PDCCH MU-MIMO; and
receiving an indication to perform the inter-UE IC, using the one or more scrambling codes, on one or more PDCCH MU-MIMO communications carried in one or more first control-channel elements (CCEs) that at least partially overlap with one or more second CCEs associated with the one or more candidate UEs.

17. The method of claim 16, wherein receiving the PDCCH MU-MIMO inter-UE IC configuration includes receiving the PDCCH MU-MIMO inter-UE IC configuration in accordance with a PDCCH blocking rate associated with CCE usage.

18. The method of claim 16, wherein receiving the PDCCH MU-MIMO inter-UE IC configuration includes receiving the PDCCH MU-MIMO inter-UE IC configuration in accordance with one or more spatial separations between the UE and the one or more candidate UEs.

19. The method of claim 16, wherein the indication to perform the inter-UE IC on the one or more PDCCH MU-MIMO communications using the one or more scrambling codes comprises a bitmap that includes a bit corresponding to the one or more scrambling codes.

20. The method of claim 16, wherein the indication to perform the inter-UE IC on the one or more PDCCH MU-MIMO communications comprises a medium access control (MAC) control element (MAC-CE) in a physical downlink shared channel (PDSCH) communication or downlink control information (DCI).
